(19) United States
(12) Patent Application Publication
(10) Pub. No.: US 2021/0230054 A1
(43) Pub. Date: Jul. 29, 2021

(54) METHOD FOR PREPARING HOLLOW GLASS MICROBEADS COATED WITH GRAPHENE OXIDE

(71) Applicant: SHENZHEN UNIVERSITY, Shenzhen (CN)

(72) Inventors: Haitao Zhuo, Shenzhen (CN); Shaojun Chen, Shenzhen (CN); Junxian Huang, Shenzhen (CN)

(21) Appl. No.: 16/311,286

(22) PCT Filed: Oct. 26, 2017
(86) PCT No.: PCT/CN2017/107818

§ 371 Date: Dec. 19, 2018

(51) Int. Cl. C03C 17/25; C03C 12/00; C03C 23/00

(52) U.S. Cl. CPC C03C 17/25; C03C 12/00; C03C 2218/111; C03C 2217/21; C03C 23/0085

(57) ABSTRACT

The present disclosure provides a method for preparing hollow glass microbeads coated with graphene oxide, which includes: dispersing graphene oxide into deionized water, to form an aqueous graphene oxide solution; placing hollow glass microbeads into the aqueous graphene oxide solution, to achieve a dispersion liquid; and simultaneously performing an ultrasonic vibration treatment and a drying treatment to the dispersion liquid, to achieve the hollow glass microbeads coated with the graphene oxide. Through simultaneously performing the ultrasonic vibration treatment and the drying treatment to the dispersion liquid, the graphene oxide is uniformly coated on the surface of the hollow glass microbeads, and thus the surface properties of the hollow glass microbeads are maintained, because no other additives such as adhesives are required.

### TECHNICAL FIELD

The present disclosure relates to the technical field of composite material, in particular to a method for preparing hollow glass microbeads coated with graphene oxide.

### BACKGROUND

Graphene oxide has good wettability and surface activity, and is capable of being peeled off after being intercalated by small molecules or polymers, thereby playing a very important role in improving the thermal, electrical, mechanical and other comprehensive properties of a material. Hollow glass microbeads have characteristics of light weight, low density, large surface area, etc., and have important application value and broad application prospects in energy, environmental protection, biomedicine and other fields, for example, reflective thermal insulation coatings, acoustic sound insulation materials, microreactors, and drug controlled release capsules, etc.

When hollow glass microbeads are coated by graphene oxide, due to the presence of the graphene oxide on the surface, their electrical conductivity can be greatly improve, and the application field of the hollow glass microbeads can be further expanded. However, the existing method for preparing hollow glass microbeads coated by graphene oxide is mainly based on physical coating, and the graphene oxide is used as a base material. The hollow glass microbeads with a surface modified by a silane coupling agent are added into a pre-dispersed aqueous graphene oxide solution. After the sedimentation of all the hollow glass microbeads, the upper layer solution is removed, and the precipitate is taken out and dried under vacuum. Finally, the hollow glass microbeads coated with the graphene oxide are achieved. However, there are defects in the conventional physical coating method such as incomplete surface coating, agglomeration of hollow glass microbeads after coating, due to the two-dimensional sheet structure of graphene oxide. Meanwhile, since a silane coupling agent is introduced onto the surface of the hollow glass microbeads, the surface properties of the hollow glass microbeads are affected to some extent.

Therefore, the following technical problems exist in the existing method for preparing hollow glass microbeads coated with graphene oxide. There are detects such as incomplete surface coating, agglomeration of hollow glass microbeads after coating, due to the two-dimensional sheet structure of graphene oxide in the conventional physical coating method. Meanwhile, since a silane coupling agent is introduced onto the surface of the hollow glass microbeads, the surface properties of the hollow glass microbeads are affected to sonic extent.

### SUMMARY

A main object of the present disclosure is to provide a method for preparing hollow glass microbeads coated with graphene oxide, which aims to solve the following technical problems in the existing method for preparing hollow glass microbeads coated with graphene oxide. That is, there are defects such as incomplete surface coating agglomeration of hollow glass microbeads after coating, due to the two-dimensional sheet structure of graphene oxide in the conventional physical coating method. Meanwhile, since a silane coupling agent is introduced onto the surface of the hollow glass microbeads, the surface properties of the hollow glass microbeads are affected to some extent.

In order to achieve the above object, the present disclosure provides a method for preparing hollow glass microbeads coated with graphene oxide, which includes:
dispersing graphene oxide into deionized water, to form an aqueous graphene oxide solution:
placing hollow glass microbeads into the aqueous graphene oxide solution, to achieve a dispersion liquid; and
simultaneously performing an ultrasonic vibration treatment and a drying treatment to the dispersion liquid, to achieve the hollow glass microbeads coated with the graphene oxide.

Further, the dispersing the graphene oxide into the deionized water to form the aqueous graphene oxide solution may include:
placing the graphene oxide into a beaker containing the deionized water, and magnetically stirring the graphene oxide and the deionized water at a preset rotation speed; and
placing the beaker into an ultrasonic disperser, and ultrasonically vibrating the magnetically stirred solution through the ultrasonic disperser, to achieve the aqueous graphene oxide solution.

Further, the simultaneously performing the ultrasonic vibration treatment and the drying treatment to the dispersion liquid to achieve the hollow glass microbeads coated with the graphene oxide may include:
placing the beaker containing the dispersion liquid into the ultrasonic disperser, and placing a heating device above the ultrasonic disperser; and
ultrasonically vibrating the dispersion liquid through the ultrasonic disperser, and drying the dispersion liquid through the heating device.

Further, the graphene oxide may have sheet diameter of 0.2 μm to 100 μm, and a structure of 1 to 3 layers.

Further, the aqueous graphene oxide solution may have a concentration of 1 mg/ml to 5 mg/ml.

Further, components of the hollow glass microbeads may include silica, calcium oxide, magnesium oxide, and sodium oxide.

Further, the hollow glass microbeads may have a particle diameter of 30 μm to 120 μm and a wall thickness of 0.7 μm to 1.2 μm.

Further, a mass of the hollow glass microbeads may be 1 to 10 times of a mass of the graphene oxide.

Further, the ultrasonic vibration treatment and the drying treatment may be performed for 1 h to 2 h.

The present disclosure provides a method for preparing hollow glass microbeads coated with graphene oxide, which includes: dispersing graphene oxide into deionized water, to form an aqueous graphene oxide solution; placing hollow glass microbeads into the aqueous graphene oxide solution, to achieve a dispersion liquid; and simultaneously performing an ultrasonic vibration treatment and a drying treatment to the dispersion liquid, to achieve the hollow glass microbeads coated with the graphene oxide. Compared the prior art, through simultaneously performing the ultrasonic vibration treatment and the drying treatment to the dispersion liquid, graphene oxide is uniformly coated on the surface of the hollow glass microbeads, and thus the surface properties of the hollow glass microbeads are maintained, because no other additives such as adhesives are required.

### BRIEF DESCRIPTION OF THE DRAWINGS

In order to illustrate the technical solutions of the present disclosure or prior art in a clearer manner, the drawings of the present disclosure or prior art will be briefly hereinafter briefly. Obviously, the following drawings merely relate to some embodiments of the present disclosure. Based on these drawings, a person skilled in the art may obtain the other drawings without any creative effort.

FIG. 1 is a schematic view showing a flow chart of a method for preparing hollow glass microbeads coated with graphene oxide according to a first embodiment of the present disclosure.

FIG. 2 is a schematic view showing the distribution density of hollow glass microbeads coated with graphene oxide prepared by 0.1 g of graphene oxide and 0.1 g of hollow glass microbeads under a scanning electron microscope;

FIG. 3 is a schematic view showing the distribution density of hollow glass microbeads coated with graphene oxide prepared by 0.4 g of graphene oxide and 0.2 g of hollow glass microbeads under a scanning electron microscope;

FIG. 4 is a schematic view showing the distribution density of hollow glass microbeads coated with graphene oxide prepared by 0.1 g of graphene oxide and 0.2 g of hollow glass microbeads under a scanning electron microscope; and

FIG. 5 is a schematic view showing the distribution density of hollow glass microbeads coated with graphene oxide prepared by 0.5 g of graphene oxide and 0.2 g of hollow glass microbeads under a scanning electron microscope.

### DETAILED DESCRIPTION

In order to illustrate the purposes, features and advantages of the present disclosure in a clearer and straightforward manner, the technical solutions in the embodiments of the present disclosure will be described hereinafter in conjunction with the drawings of the embodiments of the present disclosure in a clear and complete manner. Obviously, the following embodiments merely relate to a part of, rather than all of, the embodiments of the present disclosure. Based on these embodiments, a person skilled in the art may, without any creative effort, obtain the other embodiments, which also fall within the scope of the present disclosure.

In order to illustrate the technical solutions described in the present disclosure, it will be illustrated by way of specific embodiments hereinafter.

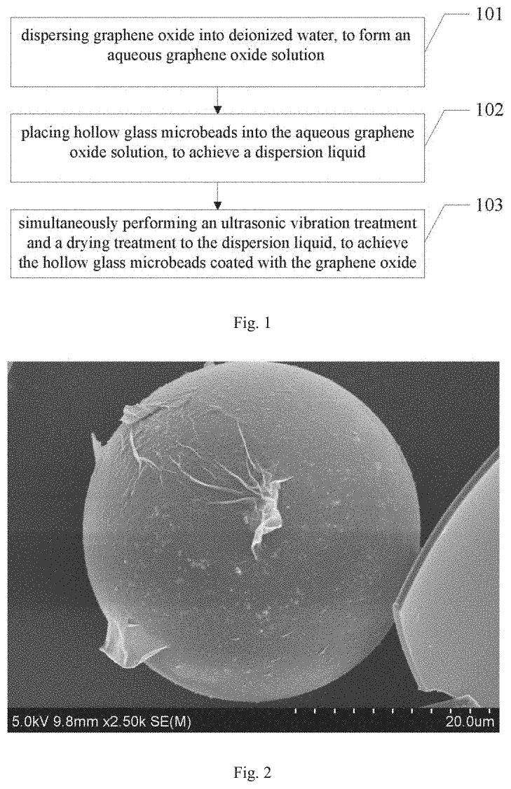

Please refer to FIG. 1, FIG. 1 is a schematic view showing a flow chart of a method for preparing hollow glass microbeads coated with graphene oxide according to a first embodiment of the present disclosure, which includes steps 101-103.

Step 101: dispersing graphene oxide into deionized water, to form an aqueous graphene oxide solution.

In the embodiment of the present disclosure, step 101 may be performed by placing the graphene oxide into a beaker containing the deionized. water, and by magnetically stirring the graphene oxide and the deionized water at a preset rotation speed, followed by placing the beaker into an ultrasonic disperser, and ultrasonically vibrating the magnetically stirred solution through the ultrasonic disperser, to achieve the aqueous graphene oxide solution.

According to the rotation speed, the magnetic stirring may be performed for 30 min to 90 min, and the ultrasonic vibrating may be performed for 30 min to 60 min.

The graphene oxide may have a sheet diameter of 0.2 μm to 100 μm, and a structure of 1 to 3 layers.

The resulting aqueous graphene oxide solution may have a concentration of 1 mg/ml to 5 mg/ml.

Step 102: placing hollow glass microbeads into the aqueous graphene oxide solution, to achieve a dispersion liquid. In the embodiment of the present disclosure, step 102 may be performed by placing hollow glass microbeads into a beaker containing an aqueous graphene oxide solution and then placing the beaker into an ultrasonic disperser, followed by ultrasonically vibrating for 30 min to 60 min, to achieve a dispersion liquid.

Components of the hollow glass microbeads may include silica, calcium oxide, magnesium oxide, and sodium oxide; and the hollow glass microbeads may have a particle diameter of 30 μm to 120 μm and a wall thickness of 0.7 μm to 1.2 μm.

It should be noted that a mass of the hollow glass microbeads may be 1 to 10 times of a mass of the graphene oxide, and the mass ratio may be determined according to actual preparation requirements.

Step 103: simultaneously performing an ultrasonic vibration treatment and a drying treatment to the dispersion liquid, to achieve the hollow glass microbeads coated with the graphene oxide. In the embodiment of the present disclosure, step 103 may be performed by placing the beaker containing the dispersion liquid into the ultrasonic disperser, and placing a heating device above the ultrasonic disperser; and ultrasonically vibrating the dispersion liquid through the ultrasonic disperser, and drying the dispersion liquid through the heating device.

The ultrasonic disperser may be filled with water in a temperature of 70° C. to 80° C. The ultrasonic vibration treatment and the drying treatment need to be performed simultaneously, and the ultrasonic vibration treatment and the drying treatment may be performed for 1 h to 2 h.

In the embodiment of the present disclosure, graphene oxide is rich in hydrophilic groups, thus the presence of the hydrophilic groups allow the graphene oxide to be uniformly dispersed in water. Further, there are a large amount of negatively charged oxygen-containing groups on the surface of the graphene oxide, thus the graphene oxide may be absorbed on the surface of the hollow glass microbeads due to the oxygen-containing groups. Finally, the ultrasonic vibration treatment and the drying treatment are simultaneously performed, so that the ultrasonic vibration treatment is performed at the same time of drying and evaporating the solvent, thus graphene oxide is uniformly coated on the surface of the hollow glass microbeads, and the agglomeration of the hollow glass microbeads also reduced, so that the resulting hollow glass microbeads coated by graphene oxide have uniform trait and good dispersibility.

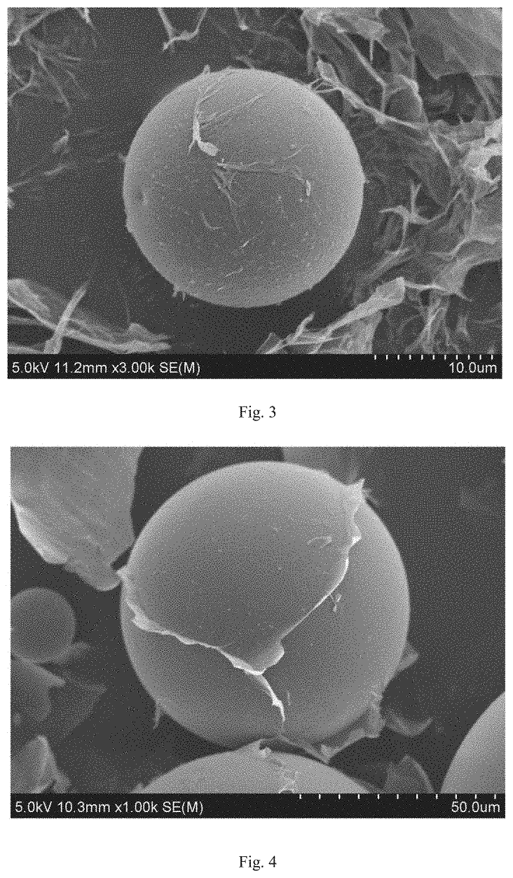

In view of FIGS. 2 to 5, it should be noted that the distribution densities of hollow glass microbeads coated with graphene oxide, achieved by different mass ratios of graphene oxide and hollow glass microbeads and by different treatment times, are different. FIG. 2 is a schematic view showing the distribution density of hollow glass microbeads coated with graphene oxide prepared by 0.1 g of graphene oxide and 0.1 g of hollow glass microbeads under a scanning electron microscope, and specifically, the hollow glass microbeads are prepared by the following steps:
(1) adding 0.1 g of graphene oxide into a beaker containing 50 ml of deionized water, and magnetically stirring at 500 r/min for 90 min, followed by placing the beaker into an ultrasonic disperser and ultrasonically vibrating for 60 min, to achieve a 2 mg/ml aqueous graphene oxide solution;
(2) taking 10 ml of the prepared graphene oxide solution in a 100 ml beaker, placing the beaker in an ultrasonic disperser, and adding 0.1 g of hollow glass microbeads into the aqueous graphene oxide solution in 3 portions with an interval of 30 min between the adding of each portion while performing ultrasonically vibrating, followed by ultrasonically vibrating for 30 min additionally, to achieve a uniformly dispersed dispersion liquid; and
(3) heating the water in the ultrasonic disperser to increase its temperature to 70° C. to 80° C., and placing a heating device right above the beaker, followed by using the ultrasonic disperser to perform an ultrasonic vibration treatment and using the heating device to perform a heat drying treatment (the ultrasonic vibration treatment and the heat drying treatment are performed for 1 h), to achieve the hollow glass microbeads coated with the graphene oxide having a distribution as shown in FIG. 2.

FIG. 3 is a schematic view showing the distribution density of hollow glass microbeads coated with graphene oxide prepared by 0.4 g of graphene oxide and 0.2 g of hollow glass microbeads under a scanning electron microscope, and specifically, the hollow glass microbeads are prepared by the following steps:
(1) adding 0.4 g of graphene oxide into a beaker containing 100 ml of deionized water, and magnetically stirring at 600 r/min for 60 min, followed by placing the beaker into an ultrasonic disperser and ultrasonically vibrating for 60 min, to achieve a 4 mg/ml aqueous graphene oxide solution;
(2) taking 10 ml of the prepared graphene oxide solution in a 100 ml beaker, placing the beaker in an ultrasonic disperser, and adding 0.2 g of hollow glass microbeads into the aqueous graphene oxide solution in 3 portions with an interval of 30 min between the adding of each portion while performing ultrasonically vibrating, followed by ultrasonically vibrating for 30 min additionally, to achieve a uniformly dispersed dispersion liquid; and
(3) heating the water in the ultrasonic disperser to increase its temperature to 70° C. to 80° C., and placing a heating device right above the beaker, followed by using the ultrasonic disperser to perform an ultrasonic vibration treatment and using the heating device to perform a heat drying treatment (the ultrasonic vibration treatment and the heat drying, treatment are performed for 1 h), to achieve the hollow glass microbeads coated with the graphene oxide having a distribution as shown in FIG. 3.

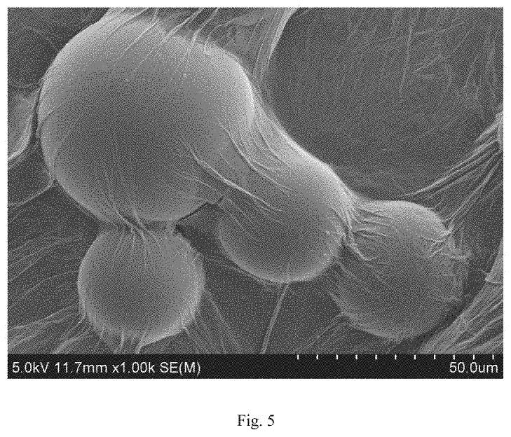

FIG. 4 is a schematic view showing the distribution density of hollow glass microbeads coated with graphene oxide prepared by 0.1 g of graphene oxide and 0.2 g of hollow glass microbeads under a scanning electron microscope, and specifically, the hollow glass microbeads are prepared by the following steps:
(1) adding 0.1 g of graphene oxide into a beaker containing 100 ml of deionized water, and magnetically stirring at 300 r/min for 60 min, followed by placing the beaker into an ultrasonic disperser and ultrasonically vibrating for 30 min, to achieve a 1 mg/ml aqueous graphene oxide solution;
(2) taking 10 ml of the prepared graphene oxide solution in a 100 ml beaker, placing the beaker in an ultrasonic disperser, and adding 0.2 g of hollow glass microbeads into the aqueous graphene oxide solution in 3 portions with an interval of 30 min between the adding of each portion while performing ultrasonically vibrating, followed by ultrasonically vibrating for 30 min additionally, to achieve a uniformly dispersed dispersion liquid; and
(3) heating the water in the ultrasonic disperser to increase its temperature to 70° C. to 80° C., and placing a heating device right above the beaker, followed by using the ultrasonic disperser to perform an ultrasonic vibration treatment and using the heating device to perform a heat drying treatment (the ultrasonic vibration treatment and the heat drying treatment are performed for 1 h), to achieve the hollow glass microbeads coated with the graphene oxide having a distribution as shown in FIG. 4.

FIG. 5 is a schematic view showing the distribution density of hollow glass microbeads coated with graphene oxide prepared by 0.5 g of graphene oxide and 0.2 g of hollow glass microbeads under a scanning electron microscope, and specifically, the hollow glass microbeads are prepared by the following steps:
(1) adding 0.5 g of graphene oxide into a beaker containing 100 ml of deionized water, and magnetically stirring at 800 r/min for 90 min, followed by placing the beaker into an ultrasonic disperser and ultrasonically vibrating for 60 min, to achieve a 5 mg/ml aqueous graphene oxide solution;
(2) taking 10 ml of the prepared graphene oxide solution in a 100 ml beaker, placing the beaker in an ultrasonic disperser, and adding 0.2 g of hollow glass microbeads into the aqueous graphene oxide solution in 3 portions with an interval of 30 min between the adding of each portion while performing ultrasonically vibrating, followed by ultrasonically vibrating for 30 min additionally, to achieve a uniformly dispersed dispersion liquid; and
(3) heating the water in the ultrasonic disperser to increase its temperature to 70° C. to 80° C., and placing a heating device right above the beaker, followed by using the ultrasonic disperser to perform an ultrasonic vibration treatment and using the heating device to perform a heat drying treatment (the ultrasonic vibration treatment and the heat drying treatment are performed for 1 h), to achieve the hollow glass microbeads coated with the graphene oxide having a distribution as shown in FIG. 5.

In view of the above FIG. 2, FIG. 3, FIG. 4 and FIG. 5, the distribution densities of the hollow glass microbeads coated with graphene oxide prepared by different mass ratios of graphene oxide and hollow glass microbeads are different.

The present disclosure provides a method for preparing hollow glass microbeads coated with graphene oxide, which includes: dispersing graphene oxide into deionized water, to form an aqueous graphene oxide solution; placing hollow glass microbeads into the aqueous graphene oxide solution, to achieve a dispersion liquid; and simultaneously performing an ultrasonic vibration treatment and a drying treatment to the dispersion liquid, to achieve the hollow glass microbeads coated with the graphene oxide. Compared with the prior art, through simultaneously performing an ultrasonic vibration treatment and a drying treatment to the dispersion liquid, graphene oxide is uniformly coated on the surface of the hollow glass microbeads, and thus the surface properties of the hollow glass microbeads are maintained, because no other additives such as adhesives are required.

In the above embodiments, descriptions of different embodiments have different emphases. If some part is not detailed in one embodiment, the related descriptions of other embodiments could be referred to.

The above is a description of a method for preparing a graphene oxide-coated hollow glass microbeads provided by the present disclosure. According to the spirit of the embodiments of the present disclosure, a person skilled in the art may make amendments to the detailed description and the range of the application thereof. To sum up, the content of the specification should not be construed as limiting the present disclosure.

1. A method for preparing hollow glass microbeads coated with graphene oxide, comprising:
dispersing graphene oxide into deionized water, to form an aqueous graphene oxide solution;
placing hollow glass microbeads into the aqueous graphene oxide solution, to achieve a dispersion liquid; and
simultaneously performing an ultrasonic vibration treatment and a drying treatment to the dispersion liquid, to achieve the hollow glass microbeads coated with the graphene oxide.

2. The method of claim 1, wherein the dispersing the graphene oxide into the deionized water to form the aqueous graphene oxide solution comprises:
placing the graphene oxide into a beaker containing the deionized water, and magnetically stirring the graphene oxide and the deionized water at a preset rotation speed; and
placing the beaker into an ultrasonic disperser, and ultrasonically vibrating the magnetically stirred solution through the ultrasonic disperser, to achieve the aqueous graphene oxide solution.

3. The method of claim 2, wherein the simultaneously performing the ultrasonic vibration treatment and the drying treatment to the dispersion liquid to achieve the hollow glass microbeads coated with the graphene oxide comprises:
placing the beaker containing the dispersion liquid into the ultrasonic disperser, and placing a heating device above the ultrasonic disperser; and
ultrasonically vibrating the dispersion liquid through the ultrasonic disperser, and drying the dispersion liquid through the heating device.

4. The method of claim 1, wherein the graphene oxide has a sheet diameter of 0.2 μm to 100 μm, and a structure of 1 to 3 layers.

5. The method of claim 1, wherein the aqueous graphene oxide solution has a concentration of 1 mg/ml to 5 mg/ml.

6. The method of claim 1, wherein components of the hollow glass microbeads comprise silica, calcium oxide, magnesium oxide, and sodium oxide.

7. The method of claim 1, wherein the hollow glass microbeads have a particle diameter of 30 μm to 120 μm and a wall thickness of 0.7 μm to 1.2 μm.

8. The method of claim 1, wherein a mass of the hollow glass microbeads is 1 to 10 times of a mass of the graphene oxide.

9. The method of claim 1, wherein the ultrasonic vibration treatment and the drying treatment are performed for 1 h to 2 h.
